(19) United States
(12) Patent Application Publication
(10) Pub. No.: US 2026/0208336 A1
(43) Pub. Date: Jul. 23, 2026

(54) TOOL FOR REMOVING GROOVE WEDGES AND METHOD

(71) Applicant: Siemens Energy Global GmbH & Co. KG, Munich, Bayern (DE)

(72) Inventors: Fene Winkler, Berlin (DE); Fabian Göbel, Berlin (DE)

(73) Assignee: Siemens Energy Global GmbH & Co. KG, Munich, Bayern (DE)

(21) Appl. No.: 19/145,932

(22) PCT Filed: Oct. 31, 2023
(86) PCT No.: PCT/EP2023/080387

§ 371 Date: Jul. 5, 2025

(30) Foreign Application Priority Data
Jan. 11, 2023 (DE) 10 2023 200 162.4

(51) Int. Cl. B25B 27/02; H02K 15/50

(52) U.S. Cl. CPC B25B 27/026; H02K 15/50

(57) ABSTRACT

A tool for removing groove wedges from grooves of a stator of a generator, wherein the tool has at least: a hollow piston cylinder, a pull rod which is connected to the hollow piston cylinder, a tool carriage which is attached to the pull rod, an attachment unit, and supports for resting on a stator.

### CROSS REFERENCE TO RELATED APPLICATIONS

This application is the US National Stage of International Application No. PCT/EP2023/080387 filed 31 Oct. 2023, and claims the benefit thereof, which is incorporated by reference herein in its entirety. The International Application claims the benefit of German Application No. DE 10 2023 200 162.4 filed 11 Jan. 2023.

### FIELD OF INVENTION

The invention relates to a tool for removing groove wedges, and to a method therefor.

### BACKGROUND OF INVENTION

The groove wedges in the stator of a generator are often removed by subtractive machining.

The stator is contaminated in the course of mechanical machining.

Alternatively, the groove wedges are removed manually while using a hammer, a chisel and another drift punch.

However, this is not always possible due to the high forces required.

US20060026818 A1 shows a tool for removing groove wedges, this tool however being too large.

### SUMMARY OF INVENTION

It is therefore an object of the invention to solve the above issue.

The object is achieved by a tool as claimed, and by a method as claimed.

Further advantageous measures are set forth in the dependent claims, which measures can be combined with one another in an arbitrary manner in order to achieve further advantages.

### BRIEF DESCRIPTION OF THE DRAWINGS

In the figures:

FIG. 1 shows a top view of part of a stator of a generator, with the tool; and

FIG. 2 shows a sectional illustration of FIG. 1.

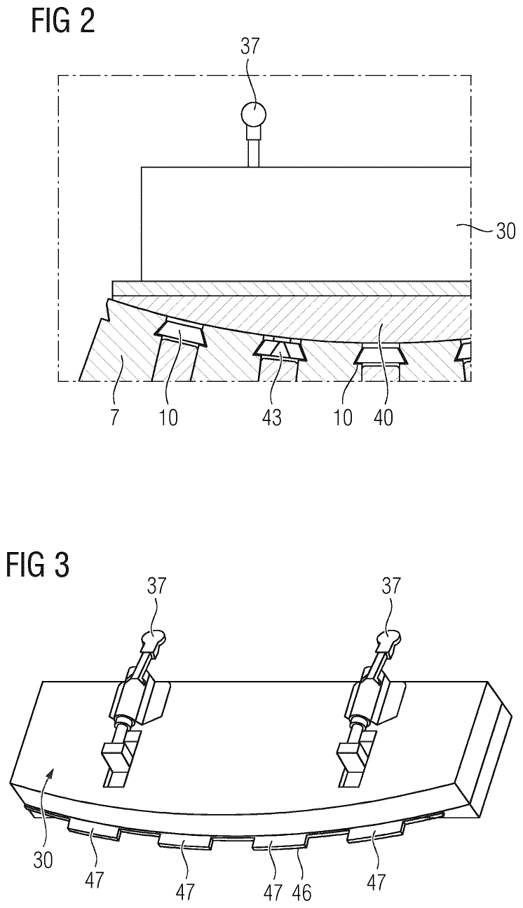

### DETAILED DESCRIPTION OF INVENTION

The description and the figures only represent exemplary embodiments of the invention.

In order to avoid the issues mentioned above, an hydraulic tool has been developed, by way of which the groove wedges are pushed axially out of the groove.

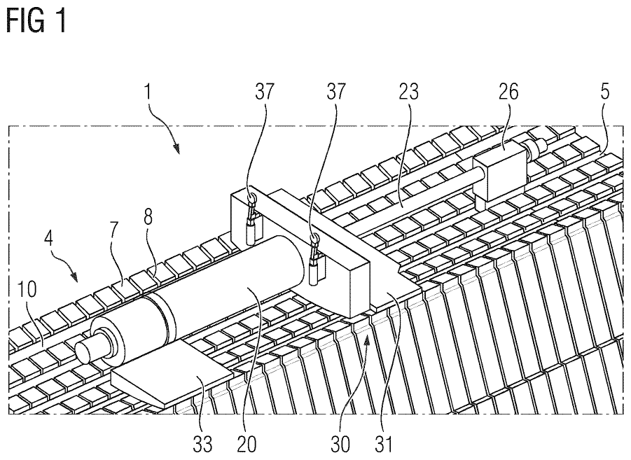

FIG. 1 shows a top view of the tool 1 which is disposed on a stator 4 of a generator.

The stator 4 has laminated cores 7 between which groove wedges 10 are present in a groove 5.

Moreover, the laminated core 7 has venting slots 8 which are transverse to a groove 5.

The groove wedges 10 are to be removed in a simple and safe manner.

The tool 1 has at least a cylinder, in particular a hollow piston cylinder 20, a pull rod 23, a tool slide 26, a fastening unit 30, and supports 31, 33.

The tool slide 26 plunges into the groove 5, or engages at the end of the groove wedge 10. The tool slide 26 is guided in the groove 5.

At the end of the groove wedge 10, the tool slide presses on the groove wedge 10. In this way, the groove wedge 10 is pushed axially out of the groove 5 by the force acting on the former.

The transmission of force from the hollow piston cylinder 20 to the tool slide 26 takes place by way of a pull rod 23 which is inserted through the hollow piston cylinder 20.

The transmission of force from the hollow piston cylinder 20 to the laminated core 7 takes place by way of the fastening unit 30.

Located on the fastening unit 30 are sliders 37 which can be pushed into the venting slots 8, in order to thus be able to transmit the force.

The sliders 37 are preferably disposed on the left and on the right of the hollow piston cylinder 20. This preferably takes place at the end of the piston 20 at which the pull rod 23 engages.

The mounting of the tool 1 takes place by way of a support 31 at the front and a support 33 at the rear on the hollow piston cylinder 20, or on the fastening unit 30, said supports being configured to be plate-shaped, corresponding to the curvature of the stator 4.

Wedges 43, which are guided in a free groove 5 and can be fastened by way of quick-release clamps, are located on the supports 31, 33.

Additionally, a transverse force support 40, which absorbs the transverse forces, on the one hand, and guides the tool 1 in the groove 5 when the latter is being displaced, on the other hand, is located on the rear support.

This transverse force support 40 is not yet required, or not required, during the initial use when drifting the groove wedges 10, because the tool rests on the stator due to gravity when starting at the lowermost position.

Thereafter, a groove has been cleared of the groove wedge 10 and can be used for supporting the transverse force.

The device makes it possible to remove the groove wedges without contaminating the stator in the process. Furthermore, damage is less likely. The arising loads are transmitted directly to the laminated core, this leading to the operator being relieved of a load. As a result, the application is more favorable and more ergonomical from a health and safety point of view.

1. A tool for removing groove wedges from grooves of a stator of a generator, comprising:
a hollow piston cylinder,
a pull rod which is connected to the hollow piston cylinder,
a tool slide which is fastened to the pull rod,
a fastening unit, and
supports for resting on a stator.

2. The tool as claimed in claim 1, further comprising:
sliders which are pushed into venting slots of a laminated core of the generator in order to transmit force.

3. The tool as claimed in claim 1,
wherein the supports comprise wedges for introducing into grooves, and/or
wherein the supports comprise transverse force supports.

4. A method for removing groove wedges from grooves of a stator of a generator, comprising:
removing groove wedges using a tool as claimed in claim 1.

5. The method as claimed in claim 4,
wherein a groove wedge is first removed at the lowest point.

6. The method as claimed in claim 5,
wherein a transverse force support engages in a free groove.
